(19) United States
(12) Patent Application Publication
(10) Pub. No.: US 2026/0199071 A1
(43) Pub. Date: Jul. 16, 2026

(54) Electric toothbrush head and electric toothbrush

(71) Applicant: Dan Gao, Huizhou City (CN)

(72) Inventor: Dan Gao, Huizhou City (CN)

(21) Appl. No.: 19/033,334

(22) Filed: Jan. 21, 2025

(30) Foreign Application Priority Data
Jan. 10, 2025 (CN) 202510047461.2

(51) Int. Cl. A61C 17/22; A46B 5/00; A46B 13/04; A61C 17/02

(52) U.S. Cl. CPC A61C 17/222; A46B 5/0095; A46B 13/04; A61C 17/02

(57) ABSTRACT

An electric toothbrush brush head and an electric toothbrush are provided. The brush head includes a head part with bristles; and a rod part extending from the head part. An interior of the rod part comprises a cavity, and a connecting portion isolated with the cavity, and an exterior of the rod part is provided with an injection port in communication with the cavity. The injection port is configured to connect a dental irrigator, and the connecting portion is configured to connect a brush handle of an electric toothbrush, the head part is provided with a nozzle in communication with the cavity, thereby a liquid from the dental irrigator is capable of flowing through the injection port, the cavity, and the nozzle in sequence.

### FIELD OF THE INVENTION

The present invention relates to the field of electric toothbrush technology, especially to an electric toothbrush head and an electric toothbrush having same.

### BACKGROUND OF THE INVENTION

With the continuous improvement of living standards, people are paying more and more attention to oral hygiene and maintenance. In order to thoroughly clean their teeth, we have created electric toothbrushes based on conventional toothbrushes. In order to extend the service life of electric toothbrushes, the brush handle with a driving shaft at the end and the brush head with bristles at the end are usually detachable and connected, so that when the bristles on the brush head are severely deformed, they can be replaced. However, current electric toothbrushes still cannot clean gaps between teeth.

### SUMMARY OF THE INVENTION

### (1) Solved technical problem

To solve the above problems, the present invention provides an electric toothbrush head and an electric toothbrush, which are easy to quickly connect with a dental irrigator, and also facilitate manufacturing and reduce production costs.

### (2) Technical solution

To achieve the above objectives, the present invention provides the following technical solution:

In one aspect, an electric toothbrush brush head includes a head part with bristles; and a rod part extending from the head part. An interior of the rod part comprises a cavity, and a connecting portion isolated with the cavity. An exterior of the rod part is provided with an injection port in communication with the cavity. The injection port is configured to connect a dental irrigator, and the connecting portion is configured to connect a brush handle of an electric toothbrush, the head part is provided with a nozzle in communication with the cavity, thereby a liquid from the dental irrigator is capable of flowing through the injection port, the cavity, and the nozzle in sequence.

In another aspect, an electric toothbrush includes a brush handle having a driving shaft, and an electric toothbrush brush head, wherein the electric toothbrush head is connected to and driven by the driving shaft.

In further another aspect, an electric toothbrush includes a brush handle mentioned above, an electric toothbrush brush head mentioned above, and a dental irrigator.

### (3) Beneficial effects

Compared with the prior art, the present invention brings the following beneficial effects:

The present electric toothbrush head has an injection port being located outside the rod part, there is no need to remove the brush handle of the electric toothbrush to connect a dental irrigator, therefore when switching between functions, only one disassembly is needed, making the operation simple and time-saving. Due to the fact that the injection port is located outside the rod part, there is no need to set channels in the driving shaft with a smaller diameter and the brush handle with a complex internal structure, making it less difficult to manufacture and lower in production costs. Overall, the electric toothbrush brush head in this application is convenient for quick connection to the toothbrush, as well as for manufacturing and reducing production costs.

Furthermore, since the brush handle and driving shaft do not require corresponding improvements based on the teeth flushing function of dental irrigator, the adaptability range of the electric toothbrush brush head in this application is wider.

Furthermore, due to the fact that the electric toothbrush brush head can be selectively connected (separately connected) or simultaneously connected to a dental irrigator and a brush handle of an electric toothbrush, the electric toothbrush brush head in this application is more flexible to use. Specifically, when the electric toothbrush brush head is separately connected to the brush handle of the electric toothbrush, it is easy to grip and carry, and can also be used as a regular electric toothbrush; when the brush head of this electric toothbrush is separately connected to the dental irrigator, it is easy to grip and carry, and can also be used as a regular dental irrigator; and when the brush head of this electric toothbrush is connected to both the dental irrigator and the brush handle of the electric toothbrush, one function can be seamlessly connected to the other after use, without the need for disassembly and assembly, making it more convenient to use.

### BRIEF DESCRIPTION OF THE DRAWINGS

FIG. 1 is a schematic structural view of an electric toothbrush with an electric toothbrush head according to an embodiment of present invention, wherein the injection port is on the rod main body.

FIG. 2 is an enlarged view of A part of the electric toothbrush head of FIG. 1.

FIG. 3 shows a brush handle of the electric toothbrush of FIG. 1, wherein the brush handle has a driving shaft.

FIG. 4 shows an opposite view of the brush handle of FIG. 3.

FIG. 5 is an enlarged view of B part of the brush handle of FIG. 4.

FIG. 6 shows an opposite view of the electric toothbrush head of FIG. 1.

FIG. 7 shows a connecting portion at the rod part of the electric toothbrush head of FIG. 6.

FIG. 8 shows a connection with a limiting structure between the rod main body and the plug of the rod part of the electric toothbrush head of FIG. 6.

FIG. 9 shows a connection with a positioning structure between the rod main body and the plug of the rod part of the electric toothbrush head of FIG. 6.

FIG. 10 is an exploded view of the rod main body and the plug of the rod part of the electric toothbrush head of FIG. 6.

FIG. 11 is a plan view of the plug of FIG. 10, wherein part of the plug is cut to show a partial sectional view of the part.

FIG. 12 is a plan view of the electric toothbrush of FIG. 1, wherein part of the rod part is cut to show an internal part of the rod part.

FIG. 13 is an enlarged view of D part of FIG. 12.

FIG. 14 is a schematic structural view of an electric toothbrush with a electric toothbrush head according to an embodiment of present invention, wherein the injection port is on the plug.

FIG. 15 shows an opposite view of the electric toothbrush head of FIG. 14.

FIG. 16 is an exploded view of the rod main body and the plug of the rod part of the electric toothbrush head of FIG. 15..

FIG. 17 is a plan view of the plug of FIG. 16, wherein part of the plug is cut to show a partial sectional view of the part.

FIG. 18 is a plan view of the electric toothbrush of FIG. 14, wherein part of the rod part is cut to show an internal part of the rod part.

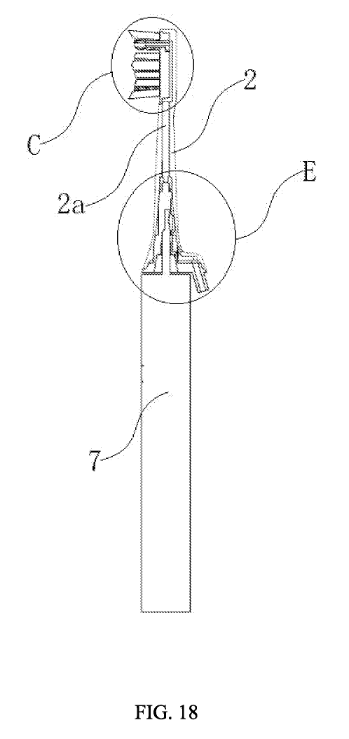

FIG. 19 is an enlarged view of C part of the head part of FIG. 18.

FIG. 20 is an enlarged view of E part of FIG. 18.

FIG. 21 shows a schematic structural view of an electric toothbrush connected to a dental irrigator according to an embodiment of present invention.

FIG. 22 shows a schematic structural view of an electric toothbrush connected to both a dental irrigator and a brush handle of the electric toothbrush according to an embodiment of present invention.

Labels in the drawing: 1, head part; 101, bristles; 2, rod part; 2a, cavity; 21, rod main body; 22, plug; 211, annular groove; 212, limiting groove; 213, positioning groove; 221, annular protrusion; 222, limiting member; 223, positioning member; 224, elastic member; 2241, first elastic portion; 2242, second elastic portion; 2243, second limiting portion; 3, injection port; 4, connecting portion; 5, nozzle; 6, sealing gel; 7, brush handle; 8, driving shaft; 81, first limiting portion; 9, dental irrigator; 91, hose.

### DETAILED DESCRIPTION OF PREFERRED EMBODIMENTS

The following will provide a clear and complete description of the technical solution in the embodiments of the present invention, in conjunction with the accompanying drawings. Obviously, the described embodiments are only a part of the embodiments of the present invention, not all of them.Based on the embodiments in the present invention, all other embodiments obtained by ordinary technicians in the art without creative labor fall within the scope of protection of the present invention.

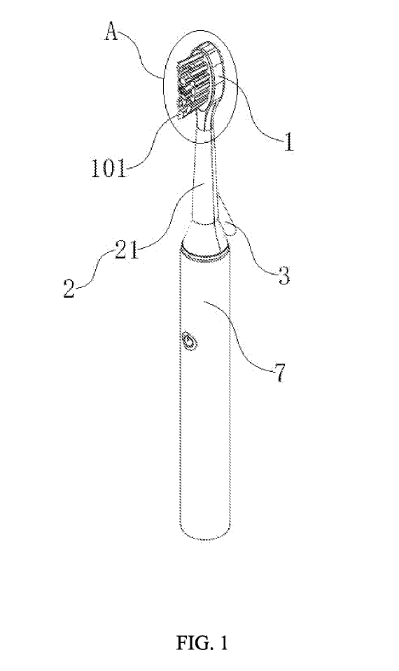

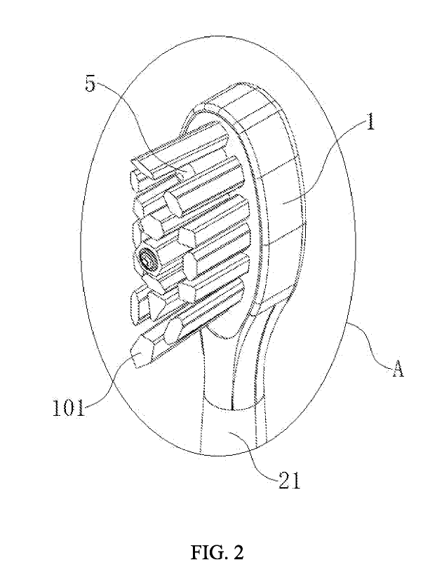

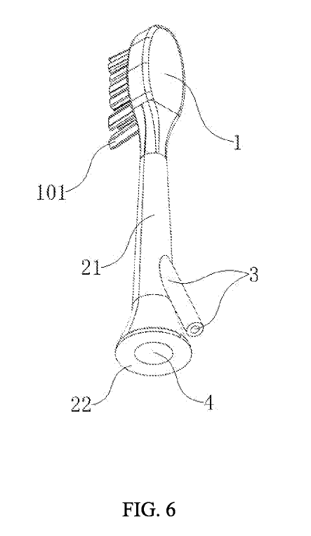

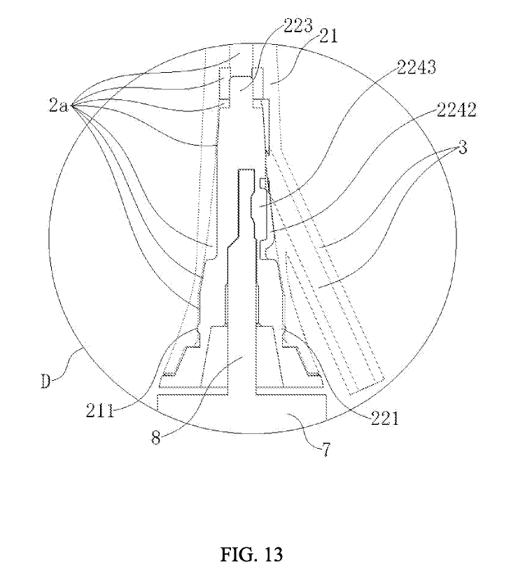

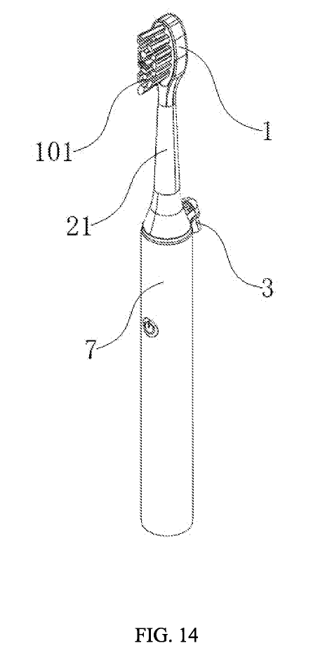

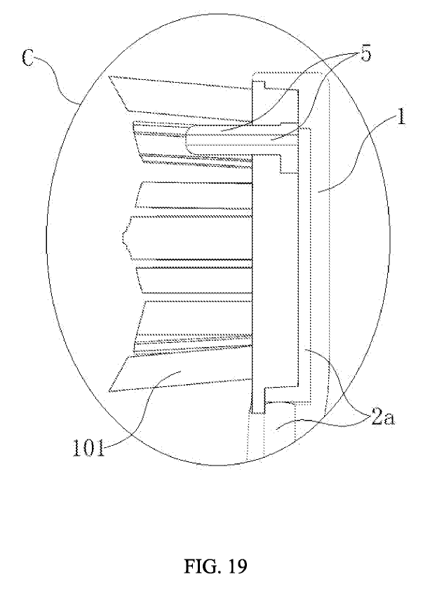

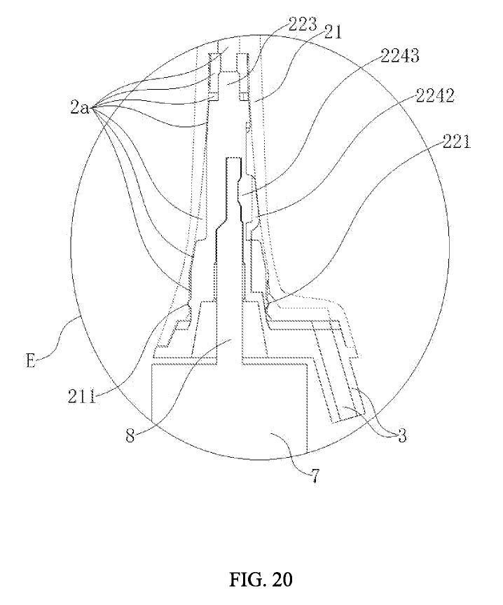

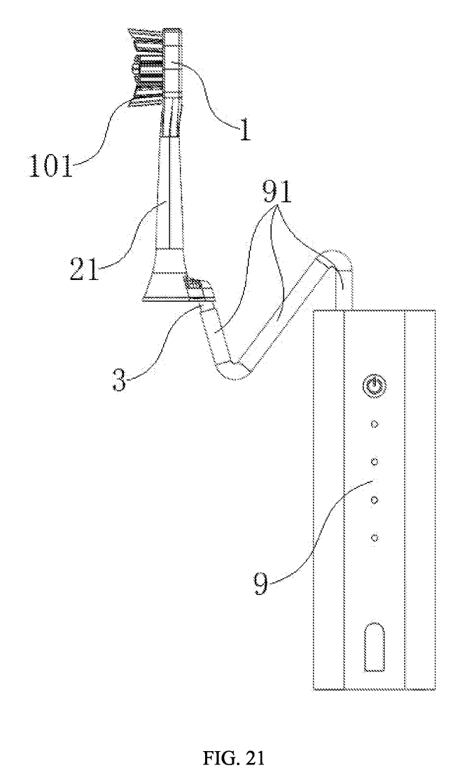

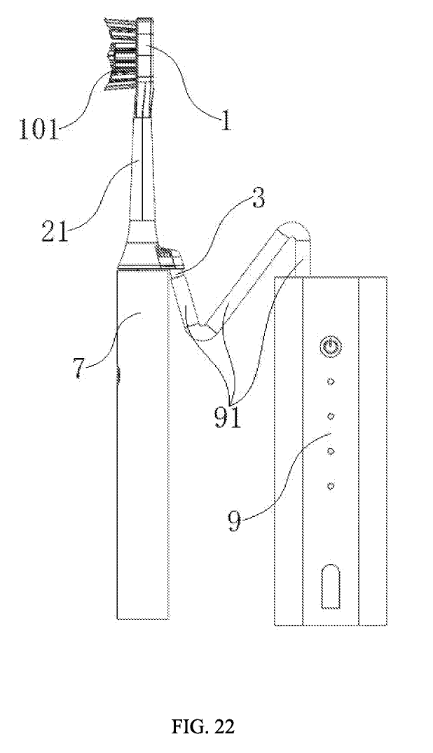

An embodiment of the present invention discloses an electric toothbrush brush head, as shown in FIG. 1 and FIG. 14, includes a head part 1 having bristles 101, and a rod part 2 extending from the head part 1, referring to FIG. 13 and FIG. 20, an interior of the rod part 2 has a cavity 2a, and referring to FIGS. 6-7 and FIG. 15, an exterior of the rod part 2 is provided with an injection port 3 in communication with the cavity 2a, and a connecting portion 4 isolated with (not in communication) the cavity 2a. Referring to FIG. 21, the injection port 3 can be connected to a dental irrigator 9, and referring to FIG. 1 and FIG. 14, the connecting portion 4 can be connected to a brush handle 7 of an electric toothbrush, or referring to FIG. 22, both the dental irrigator 9 and the brush handle 7 of an electric toothbrush are connected, so that the electric toothbrush brush head can be connected to the irrigator and the brush handle separately or simultaneously. As shown in FIG. 2 and FIG. 19, the head part 1 is provided with a nozzle 5 in communication with the cavity 2a, so that the liquid, such as water from the dental irrigator 9 can flow through the injection port 3, cavity 2a, and nozzle 5 in sequence.

In practical use, the brush handle of the electric toothbrush is connected to the connecting portion 4 at the rod part 2. Under the driving action of the brush handle of the electric toothbrush, the head part 1 can drive the bristles 101 to undergo high-frequency vibration or reciprocating rotation, thereby decomposing toothpaste and cleaning teeth. By connecting the injection port 3 on the rod part 2 to the dental irrigator 9, under the driving action of a water pump in the dental irrigator 9, the water in the water tank of the dental irrigator 9 can flow through the injection port 3 and the cavity 2a in sequence, and finally be sprayed out through the nozzle 5, thereby cleaning the teeth and gaps through pulsed water flow. Due to the fact that the injection port 3 is located outside the rod part 2, there is no need to remove the brush handle 7 of the electric toothbrush, and it can be directly connected to the dental irrigator 9. When switching functions, only one disassembly is needed, making the operation simple and time-saving. Due to the fact that the injection port 3 is located outside the rod part 2, there is no need to set channels in the driving shaft 8 with a smaller diameter and the brush handle 7 with a complex internal structure, making it less difficult to manufacture and lower in production costs. Overall, the electric toothbrush brush head in this application is convenient for quick connection to the dental irrigator 9, as well as for manufacturing and reducing production costs.

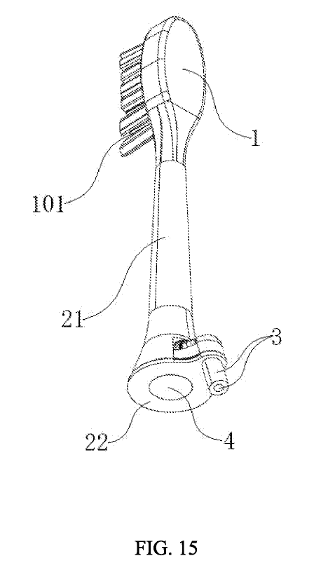

It is noted that this application does not limit the shape, size, material, color, and other parameters of the head part 1, rod part 2, injection port 3, and connecting portion 4, the size, shape, quantity, and sparsity of the bristles 101, or the number, distribution, and spraying mode of the nozzles 5. Therefore, the above components or structures can be flexibly designed according to actual needs. Referring to FIG. 6 and FIG. 15, taking injection port 3 as an example, it can be designed as a pipeline structure, and the extension direction can be designed in a straight or L-shaped shape to facilitate the connection of the dental irrigator 9.

It is noted that as long as the brush handle 7 of the electric toothbrush can be connected to the connecting portion 4 on the rod part 2, it can be used normally. Therefore, there is no limitation on the brushing mode of the electric toothbrush, and methods such as reciprocating swing or reciprocating rotation can be used to clean teeth. Similarly, as long as the dental irrigator 9 can be connected to the injection port 3 on the rod part 2, it can also be used, and pulse or ultrasonic methods can be selected to treat the water flow and rinse the teeth. Furthermore, when the brush head of the electric toothbrush is connected to both the brush handle 7 of the electric toothbrush and the dental irrigator 9, a hose 91 connecting to the water tank of the dental irrigator 9 can be installed, and the injection port 3 can be connected through the hose 91. At this time, the brush handle 7 of the electric toothbrush can be directly held to use the functions of brushing and rinsing teeth, without the need to pick up both the brush handle 7 of the electric toothbrush and the dental irrigator 9 at the same time. It is lighter in weight and has a smaller volume for easy movement, making it more convenient to use.

The above “connection” includes two ways: detachable connection and non detachable connection.

Referring to FIGS. 6, 10, 15, and 16, this embodiment introduces one of the structures of the rod part 2. Specifically, the rod part 2 includes a rod main body 21 and a plug 22, one end of the rod main body 21 is connected to the head part 1, i.e, extending from the head part 1, and the cavity 2a is set inside the rod main body 21 and opened at one end away from the head part 1. The plug 22 is detachably connected to the end of the rod part 21 away from the head part 1, and configured to seal the cavity 2a.

Based on the above scheme, except for the cavity 2a inside the rod part 21, the rest of the structure can be similar to that of a conventional electric toothbrush brush head. Therefore, with slight improvements in the manufacturing process of the traditional electric toothbrush brush head, the electric toothbrush brush head in this application can be processed and produced with less difficulty and ease of production.

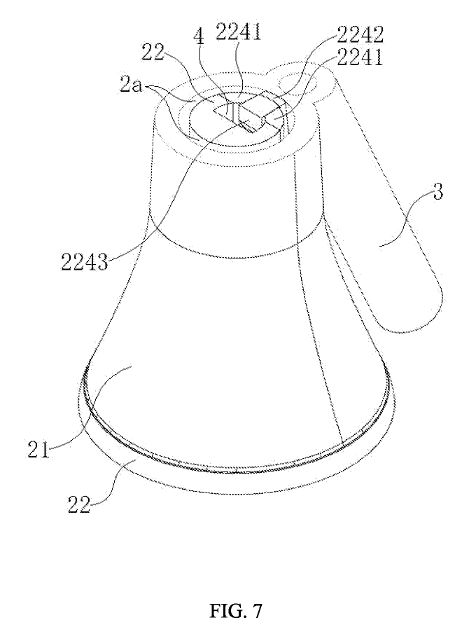

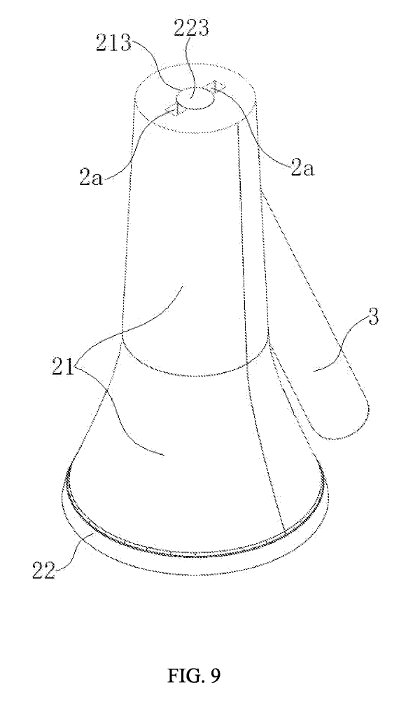

Referring to FIGS. 7-9, it should be noted that the “cavity 2a” mentioned above specifically refers to the continuous and uninterrupted space formed between the inner wall of the rod part 21 and the outer wall of the plug 22. The shape of the cavity 2a may not be regular, and the space size in different parts may not be the same. However, when the rod part 21 is placed vertically, there will be space in each horizontal section of the cavity 2a from top to bottom, so that liquid can flow in the cavity 2a.

Furthermore, the rod main body 21 and the plug 22 can be fixedly connected or directly integrated to enhance the sealing performance of the cavity 2a.

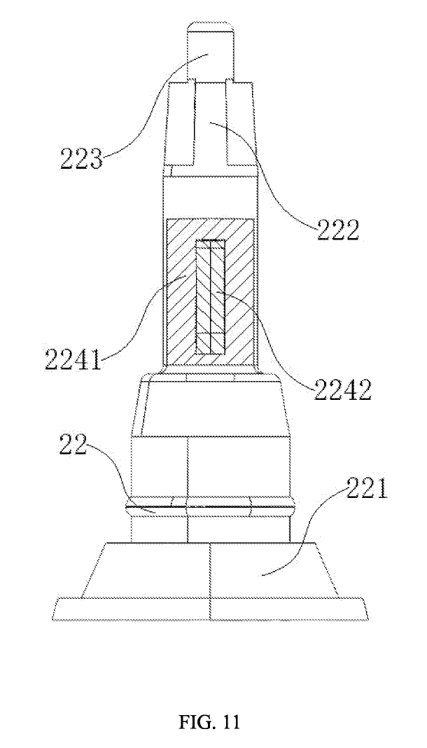

Referring to FIGS. 11, 13, 17, and 20, there are various ways and structures of detachable connection. One of them is introduced in this embodiment. Specifically, the inner wall of the rod main body 21 is provided with a substantially annular groove 211, and the plug 22 is provided with a substantially annular protrusion 221 corresponding to the annular groove 211. The edge of the annular protrusion 221 is formed in a substantially arc shape. At least one of the rod main body 21, plug 22, and annular protrusion 221 has elasticity, and the rod main body 21 and plug 22 can be connected by the engagement of the annular groove 211 and annular protrusion 221, and the engagement of the annular groove 211 and annular protrusion 221 can help seal a lower end of the cavity 2a.

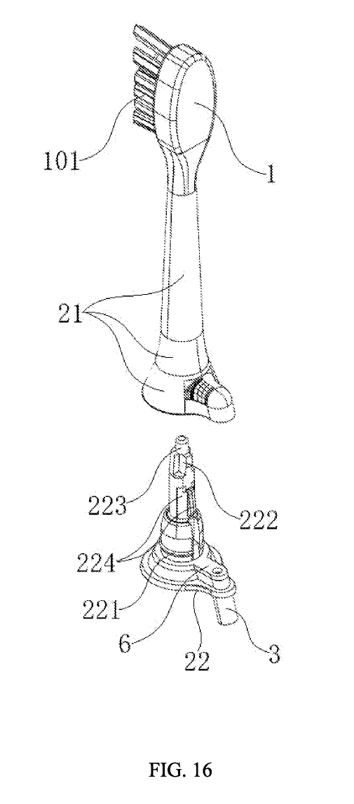

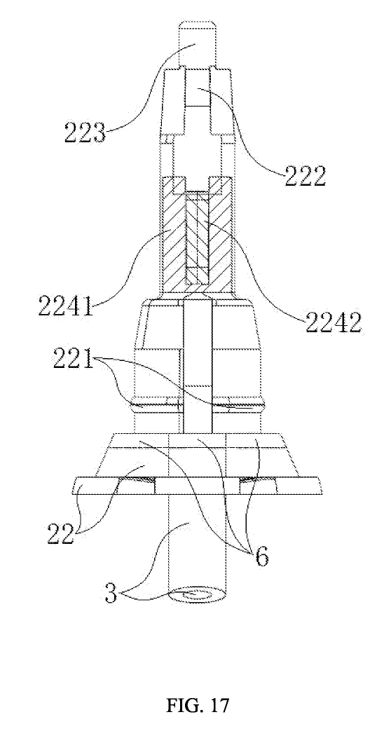

Referring to FIGS. 16 and 17, due to the detachable connection between the rod main body 21 and the plug 22 in the above scheme, there may be some gaps in the connection part between the two after connection. In order to avoid liquid leakage from the cavity 2a, the following design is carried out in this embodiment. Specifically, a sealing gel 6 is filled between the rod main body 21 and the plug 22.

By designing the above structure, the sealing performance of cavity 2a can be effectively enhanced. Furthermore, the sealing gel 6 has obvious elasticity, so after the rod main body 21 and the plug 22 are connected, the sealing gel 6 can be in a deformed state after being squeezed, thereby further enhancing the sealing performance of the empty air strength 2a through the elasticity of the sealing gel 6 itself.

Referring to FIG. 16, it should be noted that the sealing gel 6 is set in a staggered position with the injection port 3, or a hole-shaped structure connected to the injection port 3 is set in the sealing gel 6 to prevent obstruction to the flow of liquid.

The present application does not limit the position of the injection port 3 on the rod part 2, so it can be selectable designed according to the actual situation. On the case that the rod part 2 includes a rod main body 21 and a plug 22, there are two design methods for the injection port 3 on the rod part 2, specifically, the first option, as shown in FIG. 6 and FIG. 13, is to set the injection port 3 on the rod main body 21; the second option, as shown in FIGS. 15 and 20, is to set the injection port 3 on the plug 22.

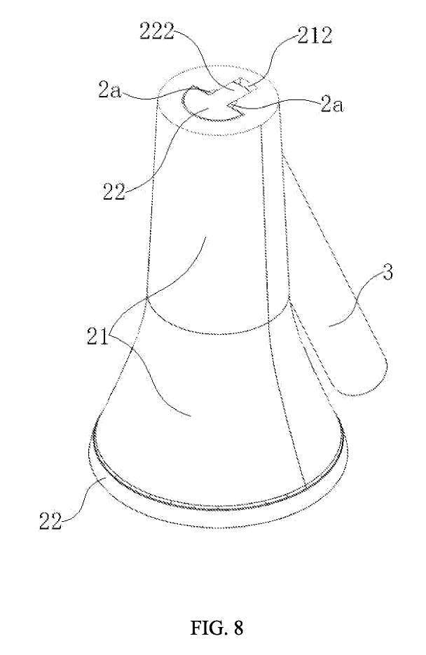

Referring to FIGS. 8-11, the structure of the rod main body 21 and the plug 22 is often similar to that of a rotating body. In order to prevent them from rotating after being connected, the following design is carried out in this embodiment, specifically, the rod main body 21 is equipped with a limiting groove 212 and a positioning groove 213 inside, and the plug 22 is equipped with a limiting member 222 corresponding to the limiting groove 212 and a positioning member 223 corresponding to the positioning groove 213. After the rod main body 21 and the plug 22 are connected, the limiting member 222 can be inserted into the limiting groove 212, and the positioning member 223 can be inserted into the positioning groove 213.

Through the design of the above structure, after connecting the rod main body 21 and the plug 22, the limiting member 222 can be inserted into the limiting groove 212 to prevent the rod main body 21 and the plug 22 from rotating relative to each other. In addition, after the connection between the rod main body 21 and the plug 22, the positioning member 223 can be inserted into the positioning groove 213 to prevent the rod main body 21 and the plug 22 from shaking and being displaced from each other, making the connection between the rod main body 21 and the plug 22 more stable and firm.

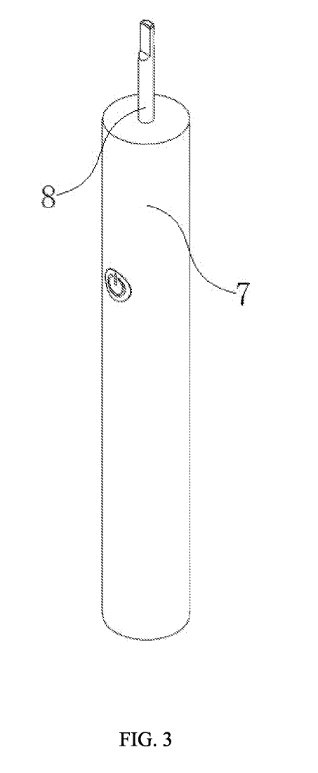

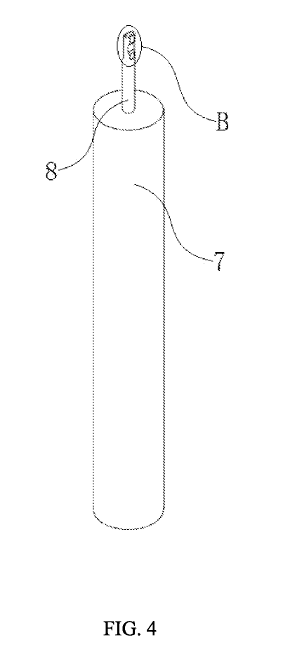

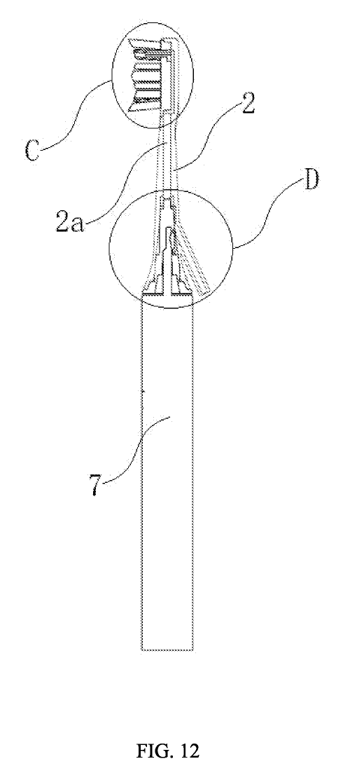

Referring to FIGS. 3-6 and FIGS. 10-13, in order to have a clearer understanding of how the connecting portion 4 is connected to the electric toothbrush, the connecting portion 4 is designed as follows based on the rod part 2 including of the rod main body 21 and the plug 22 in this embodiment. Specifically, the connecting portion 4 is formed in the plug 22 and in an elongated groove shape, with an elastic member 224 provided therein. The elastic member 224 includes a second limiting portion 2243 facing the connecting portion 4. The electric toothbrush includes a brush handle 7 having a driving shaft 8, the driving shaft 8 has a first limiting portion 81 corresponding to the second limiting portion 2243. The driving shaft 8 can be inserted into the connecting portion 4, and the driving shaft 8 and the connecting portion 4 forms an engagement, in manner of cantilever buckle connection through the first limiting portion 81 and the second limiting portion 2243. After the connection part 4 is connected to the driving shaft 8, there is a gap between the end of the electric toothbrush brush head near the brush handle 7 and the end of the brush handle 7 near the electric toothbrush brush head.

Based on the above scheme, since the driving shaft 8 can be inserted into the connecting portion 4 and connected with a cantilever buckle, the electric toothbrush brush head can be detached from the brush handle 7 of the electric toothbrush. Therefore, the electric toothbrush brush head can be easily replaced in case of dirt or damage. In addition, due to the connection between the connecting portion 4 and the driving shaft 8, there is a gap between the end of the electric toothbrush brush head near the brush handle 7 and the end of the brush handle 7 near the electric toothbrush brush head, therefore, while the driving shaft 8 vibrates, it can also drive the rod part 2 and the head part 1 to vibrate, and the vibration of the rod part 2 will not be hindered by the brush handle 7.

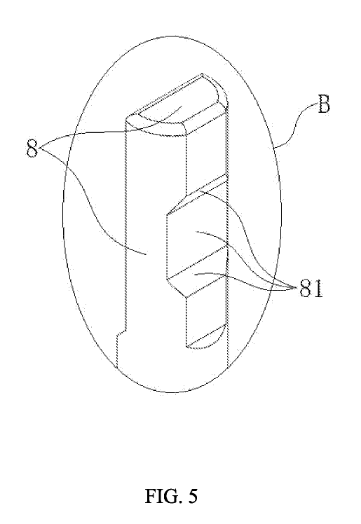

It is noted that the specific structures of the first limiting portion 81 and the second limiting portion 2243 are not limited in this embodiment, so they can be selectable designed according to actual needs. Based on the principle that “after the driving shaft 8 is inserted into the connecting portion 4, the cantilever buckle connection can be achieved through the cooperation of the first limiting portion 81 and the second limiting portion 2243”, the first limiting portion 81 can be designed as a protruding structure, and the second limiting portion 2243 can be designed as a groove structure corresponding to the above-mentioned protruding structure. Alternatively, referring to FIGS. 5, 13, and 20, the first limiting portion 81 is designed as a groove structure, and the second limiting portion 2243 is designed as a protruding structure corresponding to the above groove structure.

It should be noted that the “elastic member 224” mentioned above is one part of the “plug 22”, that is, the elastic member 224 belongs to the plug 22, which is integrated formed. Due to the obvious elasticity of the elastic member 224 and the significant difference in material from other parts of the plug 22, it can be produced using a two-color injection molding process. In this application, for the convenience of understanding, the part where the elastic member 224 is located is separated from other parts of the plug 22 by a line for illustration. In addition, due to the obvious elasticity and deformability of the “elastic member 224” mentioned above, the first limiting portion 81 and the second limiting portion 2243 may or may not have elasticity, and regardless of whether they have elasticity, they will not affect the buckle connection between the driving shaft 8 and the connecting portion 4.

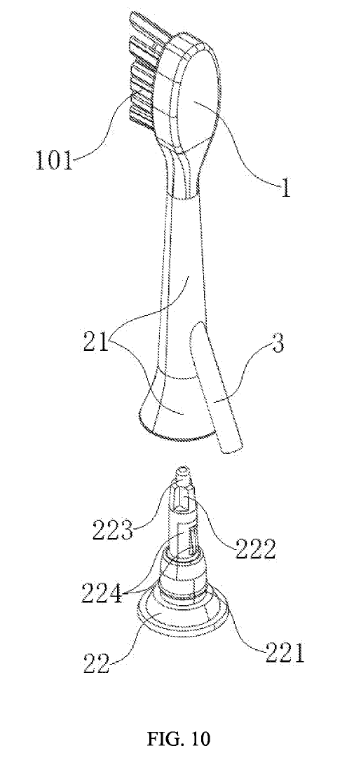

Referring to FIG. 10 and 16, in order to ensure the sealing of the cavity 2a, the following design is carried out in this embodiment, based on the fact that “the rod part 2 includes a rod main body 21 and a plug 22, the connecting portion 4 is set in the plug 22, and the connecting portion 4 is an elongated groove structure with an elastic member 224 provided therein”, the elastic member 224 is an enclosed structure, such as a continuous sheet without one or more hollowed-out structures, so that the elastic member 224 can seal at least one side of the connecting portion 4 and prevent the liquid such as water in the cavity 2a from leaking out from the elastic member 224.

Referring to FIGS. 5, 13, and 20, there are various structures that can be used for buckle connections. In this embodiment, the following design has been implemented: specifically, the second limiting portion 2243 is a tooth shaped structure, and the first limiting portion 81 is provided with a corresponding tooth groove structure.

Referring to FIGS. 7, 10, 11, and 13, or FIGS. 7, 16, 17, and 20, based on the above scheme, this embodiment has been designed as follows. Specifically, the elastic member 224 further includes two first elastic portions 2241 located on both sides of the second limiting portion 2243, a flexibility of the first elastic portions 2241 is greater than that of second limiting portion 2243, for example, the first elastic portions 2241 is made of a softer elastic material and the second limiting portion 2243 is made of a deformable harder material.

Through the design of the above structure, the second limiting portion 2243 will be hindered by the first elastic portions 2241 during the deformation process, thus indirectly enhancing the elastic deformation ability of the second limiting portion 2243, making the elastic force generated by the second limiting portion 2243 greater under the same deformation amount, and the connection between the second limiting portion 2243 and the first limiting portion 81 more stable and firm.

Referring to FIG. 7, further design has been made in this embodiment. Specifically, a second elastic portion 2242 made of a soft elastic material is provided on the side of the elastic member 224 away from the second limiting portion 2243. After the rod main body 21 and the plug 22 are connected, the second elastic portion 2242 can abut and press against the inner wall of the rod main body 21.

Based on the above scheme, since the driving shaft 8 and the connecting portion 4 can be connected by a cantilever buckle through the cooperation of the first limiting portion 81 and the second limiting portion 2243, regardless of whether the second limiting portion 2243 is a groove structure or a protruding structure, during the process of connecting the driving shaft 8 and the connecting portion 4, the second limiting portion 2243 will be offset or deformed in a direction away from the first limiting portion 81 until the second limiting portion 2243 is engaged with the first limiting portion 81. Under the squeezing action of the inner wall of the rod main body 21, the second elastic portion 2242 will undergo elastic deformation towards the direction close to the first limiting portion 81, and compress the second limiting portion 2243, which will hinder the deformation of the second limiting portion 2243 towards the direction away from the first limiting portion 81, thereby further enhancing the elastic deformation ability of the second limit portion 2243. In the case of the same deformation amount, the second limiting portion 2243 will generate greater elastic force, making it more difficult for the first limiting portion 81 and the second limiting portion 2243 to detach from each other after being engaged.

Referring to FIGS. 1 and 3, an embodiment of the present invention also discloses an electric toothbrush, which includes an electric toothbrush brush head and a brush handle 7. The brush handle 7 is provided with a driving shaft 8, and the electric toothbrush brush head is connected to the driving shaft 8.

It should be noted that the terms used here are only intended to describe specific embodiments and are not intended to limit the exemplary embodiments according to the present application. As used herein, unless otherwise explicitly stated in the context, the singular form is also intended to include the plural form. Additionally, it should be understood that when the terms “including” and/or “including” are used in this specification, they indicate the presence of features, steps, operations, devices, components, and/or combinations thereof.

In addition, it should be noted that the use of words such as “first” and “second” to define components is only for the purpose of distinguishing the corresponding components. If not otherwise stated, the above words do not have a special meaning and therefore cannot be understood as limiting the scope of protection of this application.

Although embodiments of the present invention have been shown and described, it can be understood by those skilled in the art that multiple variations, modifications, substitutions, and variations can be made to these embodiments without departing from the principles and spirit of the present invention. The scope of the present invention is limited by the accompanying claims and their equivalents.

What is claimed is:

1. An electric toothbrush brush head comprising:
a head part with bristles; and
a rod part extending from the head part, wherein an interior of the rod part comprises a cavity, and a connecting portion isolated with the cavity, an exterior of the rod part is provided with an injection port in communication with the cavity, the injection port is configured to connect a dental irrigator, and the connecting portion is configured to connect a brush handle of an electric toothbrush, the head part is provided with a nozzle in communication with the cavity, thereby a liquid from the dental irrigator is capable of flowing through the injection port, the cavity, and the nozzle in sequence.

2. The electric toothbrush brush head according to claim 1, wherein the rod part comprises:
a rod main body extending from the head part, the cavity being set inside the rod main body and opened at an end of the rod main body away from the head part.
a plug detachably connected to the end of the rod main body away from the head part, and the plug sealing the cavity at the end.

3. The electric toothbrush brush head according to claim 2, wherein an inner wall of the rod main body is provided with a substantially annular groove, and the plug is provided with a substantially annular protrusion corresponding to the annular groove, at least one of the rod main body, the plug, and annular protrusion has elasticity, and the rod main body and plug can be connected by the engagement of the annular groove and annular protrusion.

4. The electric toothbrush brush head according to claim 2, wherein a sealing gel is filled between the rod main body and the plug.

5. The electric toothbrush brush head according to claim 2, wherein the injection port is arranged on the rod main body.

6. The electric toothbrush brush head according to claim 2, wherein the injection port is arranged on the plug.

7. The electric toothbrush brush head according to claim 3, wherein the interior of the rod main body further comprises a limiting groove and a positioning groove, and the plug further comprises a limiting member corresponding to the limiting groove and a positioning member corresponding to the positioning groove, after the rod main body and the plug are connected, the limiting member is inserted into the limiting groove, and the positioning member is inserted into the positioning groove.

8. The electric toothbrush brush head according to claim 2, wherein the connecting portion is formed in the plug and in an elongated groove shape, and an elastic member is arranged in the connecting portion, the elastic member comprises a second limiting portion facing the connecting portion; the brush handle of the electric toothbrush comprises a driving shaft, the driving shaft comprises a first limiting portion corresponding to the second limiting portion, the driving shaft is capable of inserting into the connecting portion, and the driving shaft is connected to the connecting portion through an engagement between the first limiting portion and the second limiting portion.

9. The electric toothbrush brush head according to claim 8, wherein after the connection part is connected to the driving shaft, there is a gap between an end of the electric toothbrush brush head near the brush handle and an end of the brush handle near the electric toothbrush brush head.

10. The electric toothbrush brush head according to claim 8, wherein the elastic member is an enclosed structure and seals a side of the connecting portion.

11. The electric toothbrush brush head according to claim 8, wherein the second limiting portion is a tooth shaped structure, and the first limiting portion is a tooth groove shaped structure corresponding to the tooth shaped structure.

12. The electric toothbrush brush head according to claim 8, wherein the elastic member further comprises two first elastic portions arranged on two opposite sides of the second limiting portion, a flexibility of the first elastic portions is greater than that of the second limiting portion.

13. The electric toothbrush brush head according to claim 8, wherein a second elastic portion is provided on a side of the elastic member away from the second limiting portion, after the rod main body and the plug are connected, the second elastic portion abuts against the inner wall of the rod main body.

14. An electric toothbrush, comprising a brush handle having a driving shaft, and an electric toothbrush brush head according to claim 1, wherein the electric toothbrush head is connected to and driven by the driving shaft.

15. An electric toothbrush brush comprising:
a head part with bristles;
a rod part extending from the head part, wherein an interior of the rod part comprises a cavity, and a connecting portion isolated with the cavity, an exterior of the rod part is provided with an injection port in communication with the cavity,
a dental irrigator; and
a brush handle of an electric toothbrush,
wherein the injection port is configured to connect the dental irrigator, and the connecting portion is configured to connect the brush handle of an electric toothbrush, the head part is provided with a nozzle in communication with the cavity, thereby a liquid from the dental irrigator is capable of flowing through the injection port, the cavity, and the nozzle in sequence.

16. The electric toothbrush brush according to claim 15, wherein the dental irrigator and the brush handle of the electric toothbrush are selectively connected or simultaneously connected.
